(19) United States
(12) Patent Application Publication
(10) Pub. No.: US 2025/0363899 A1
(43) Pub. Date: Nov. 27, 2025

(54) SYSTEM AND METHOD FOR EMERGENCY RESPONSE

(71) Applicant: HELPYFINDER, INC., San Francisco, CA (US)

(72) Inventor: Shailesh Kumar Agrahari, Tracy, CA (US)

(21) Appl. No.: 19/213,059

(22) Filed: May 20, 2025

Related U.S. Application Data
(60) Provisional application No. 63/650,717, filed on May 22, 2024.

(51) Int. Cl. G08G 5/80; B64U 70/92; B64U 101/55; G01C 21/20; G06V 10/764; G06V 20/52; H04N 7/18

(52) U.S. Cl. CPC G08G 5/80; B64U 70/92; G01C 21/20; G06V 10/764; G06V 20/52; H04N 7/185; B64U 2101/55

(57) ABSTRACT

An emergency response portable device includes: a housing; a microcontroller; a memory for storing software; a flying object docked to the portable device; a docking platform for docking the flying object; a communication circuit; and an activation mechanism to activate an emergency response from the portable device in case of an emergency situation including a fall or a crash. When the portable device is activated in case of the emergency situation, the flying object is released from the docking platform to hover in the air to maintain a position above the portable device, and the communication circuit transmits an emergency signal to a remote location reporting the emergency situation.

### CROSS-REFERENCE TO RELATED APPLICATIONS

This patent application claims the benefits of U.S. Provisional Patent Application Ser. No. 63/650,717, filed on May 22, 2024, and entitled “System and Method for Emergency Response,” the entire content of which is hereby expressly incorporated by reference.

### FIELD

The present disclosure relates generally to the field of software and electronic devises. More specifically, the present disclosure pertains to a system and method for personal safety and emergency response.

### BACKGROUND

In critical scenarios like personal emergencies, road accidents, where rapid aerial response can be vital for assessment and communication, existing solutions fall short. They lack integration with real-time accident detection systems and do not support fully autonomous deployment from protective enclosures.

Moreover, current drone technologies are primarily designed for general-purpose applications and often require manual preparation before flight, such as unfolding arms and placing them on a take-off surface. While some foldable drones exist, they are not equipped for automated emergency deployment.

### SUMMARY

To overcome the above challenges, a potable drone-based real-time emergency system housed in a compact, protective triggers the box to open automatically, when an accident is detected. After the box opens, a drone is airborne to perform surveillance and/or communication tasks. This system minimizes manual intervention, reduces response time, and enhances portability, making it ideal for emergency applications where every second counts

The present disclosure relates to the field of personal safety and emergency response technologies, integrating advanced communication, surveillance, and artificial intelligence to enhance individual and community security.

In some embodiment, an emergency response portable device includes: a housing; a microcontroller; a memory for storing software; a flying object docked to the portable device; a docking platform for docking the flying object; a communication circuit; and an activation mechanism to activate an emergency response from the portable device in case of an emergency situation including a fall or a crash. When the portable device is activated in case of the emergency situation, the flying object is released from the docking platform to hover in the air to maintain a position above the portable device, and the communication circuit transmits an emergency signal to a remote location reporting the emergency situation.

In some embodiment, a method, executed on a portable device, for emergency response to an emergency situation, includes: detecting an emergency situation including a fall or a crash; classifying a nature of the emergency; releasing a flying object docked to the portable device to hover in the air to maintain a position above the portable device; and transmitting an emergency signal to a remote location reporting the emergency situation, wherein the emergency signal includes a location of the portable device, the nature of the emergency and health parameters of a user of the portable device.

### BRIEF DESCRIPTION OF THE DRAWINGS

A more complete appreciation of the disclosure, and many of the attendant features and aspects thereof, will become more readily apparent as the disclosure becomes better understood by reference to the following detailed description when considered in conjunction with the accompanying drawings in which like reference symbols indicate like components.

FIG. 1A shows an exemplary wearable or portable device, FIG. 1B shows an example portable device, and FIG. 1C shows a detachable flying object equipped with a camera, according to some embodiments of the disclosure.

FIG. 2 shows an exemplary emergency response device, according to some embodiments of the disclosure.

FIG. 3 depicts as exemplary emergency response device with a docking platform, according to some embodiments of the present disclosure.

FIG. 4 depicts as exemplary flying object with a docketing mechanism, according to some embodiments of the present disclosure.

FIG. 5 illustrates an exemplary process flow of an emergency response for a wearable or portable device, according to some embodiments of the present disclosure.

FIG. 6 illustrates as exemplary process flow for usage of a wearable or portable device, according to some embodiments of the present disclosure.

FIG. 7 shows as exemplary process flow for predictive crime and emergency alerts, according to some embodiments of the present disclosure.

FIG. 8 depicts as exemplary process flow for model training and notification generation of a wearable or portable device, according to some embodiments of the present disclosure.

FIG. 9 shows as exemplary process flow for a requester's process, according to some embodiments of the present disclosure.

### DETAIL DESCRIPTION

In some embodiments, the emergency response portable device of the present disclosure includes two primary components: a mobile application and a wearable or portable device communicating with the mobile application.

The mobile application (app) serves as a comprehensive platform that connects individuals seeking immediate help with nearby users who can provide assistance. This connection is facilitated through real-time geolocation tracking to enable rapid response in emergency situations. In some embodiments, the mobile app includes features such as one-tap emergency alerts, live video streaming, and a community response system that leverages local nearby app users to offer prompt aid.

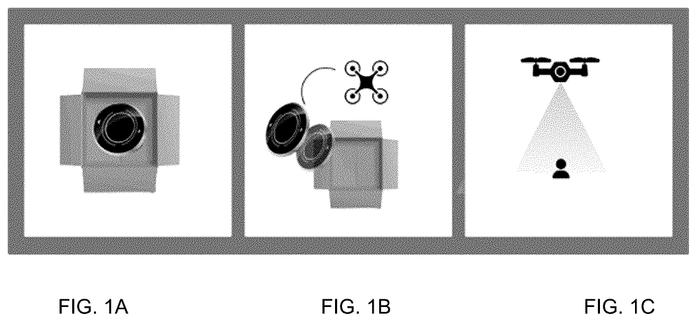

FIG. 1A shows an exemplary wearable or portable device, FIG. 1B shows an example portable device, and FIG. 1 C shows a detachable flying object equipped with a camera, according to some embodiments of the disclosure. As shown, the wearable and/or portable component of the disclosure, is a versatile device that can be worn on various parts of the body or carried in personal items such as a purse, a bag or a clothing pocket (e.g., FIG. 1A). In some embodiments, the component includes a detachable flying object equipped with a high-resolution camera (e.g., FIG. 1C) that, upon activation, hovers in the air over the user to record and stream video footage (e.g., FIG. 1C). This aerial perspective is particularly useful in monitoring and recording emergencies, providing both the user and responders with real-time situational live streaming/awareness. The portable device may have a claps mechanism to be able to wear it on the hand, arm, wrist, back, waist or other parts of a body. Herein thereafter, the term referred to as a “portable device” includes a wearable capability.

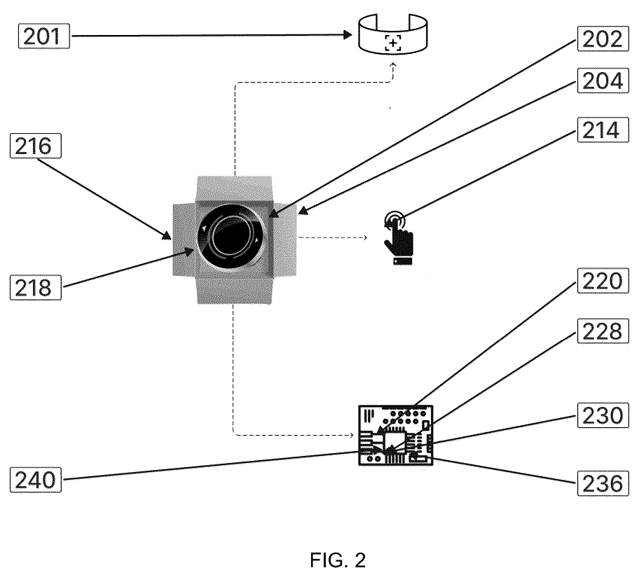

FIG. 2 shows an exemplary emergency response device, according to some embodiments of the disclosure. The modular device 202 includes a memory which stores related firmware and software for the operation of the device. In some embodiments, the firmware/software uses a modular design with a real-time operating system (RTOS) for efficient multitasking and focusing on real-time responsiveness. In some embodiments, the modular device features a wristband 201 with a modular design that allows users to easily swap out components such as the battery, sensor modules, or the display. In some embodiments, a housing 204 is constructed with a composite material that for example, combines lightweight metals and polymers, engineered for toughness and resilience. It provides substantial protection against impacts, drops, and harsh environmental conditions, ensuring long-term durability.

In some embodiments, the wristband includes a clasp mechanism that incorporates a secure, easy-to-fasten clasp mechanism that prevents accidental openings, ensuring the wristband remains securely on the user's wrist during vigorous activities. In some embodiments, the device employs vibration isolating materials around sensitive components like a microcontroller unit (MCU) 230 and biometric sensors 236 to prevent errors or disruptions in sensor readings due to motion or ambient vibrations, ensuring accurate data collection.

In some embodiments, a touch-sensitive surface 214 includes a capacitive touch-sensitive area, for example, on the band, allowing for gesture controls such as swiping and tapping to control the device's features. In some embodiments, a physical activation button or mechanism 216 is ergonomically placed to provide tactile feedback for emergency activations, ensuring reliability under stress. In some embodiments, the portable device is automatically activated in a case of a fall, a crash or an impact by the activation mechanism 216 including a gyroscope, gyrometer or the like that detects the fall or the crash.

In some embodiments, a display 218 incorporates a small, energy-efficient OLED display for showing system statuses, alerts, and notifications. In some embodiments, a communication module/circuit 220 employs Bluetooth and Wi-Fi for high-speed, reliable communication between the wristband, the flying object, and the paired smartphone application. In some embodiments, a GPS module 228 tracks location of the device to relay the wearer's/carrier's location.

In some embodiments, MCU 230 integrates an ARM Cortex-M microcontroller, which manages device operations, sensor data processing, and communication protocols efficiently. In some embodiments, an ultra-wideband (UWB) module employs UWB technology for precise, real-time location tracking within complex environments, enhancing the accuracy of services like indoor navigation. In some embodiments, the display 218 is made with a flexible substrate, allowing it to conform to the curvature of the wristband, enhancing durability and maintaining visibility from multiple angles.

In some embodiments, biometric sensors 236 incorporate advanced sensors capable of monitoring parameters such as blood oxygen levels, skin temperature, and electrodermal activity, offering comprehensive health tracking. In some embodiments, a multi-factor authentication, including biometrics and passcodes, enhances security when accessing sensitive functions or personal data. In some embodiments, communication module/circuit 220 supports 5G cellular networks to provide faster and more reliable internet connectivity, ensuring uninterrupted communication even in densely populated areas. In some embodiments, communication module/circuit 220 is capable of communicating with a mobile computing device, such as a smart phone, a tablet or a laptop to set programing parameters, add contacts, and communicate various data as live video feed, audio capture, GPS coordinates, altitude data, battery level, speed and direction, environmental temperature, humidity levels, air quality index, infrared imaging, collision detection data, vibration patterns, pressure readings, proximity alerts, signal strength, wind speed and direction, light intensity, object recognition data, facial recognition data, emotion detection, motion tracking data, crowd density estimation, anomaly detection, license plate recognition, scene reconstruction, path prediction, and/or text recognition.

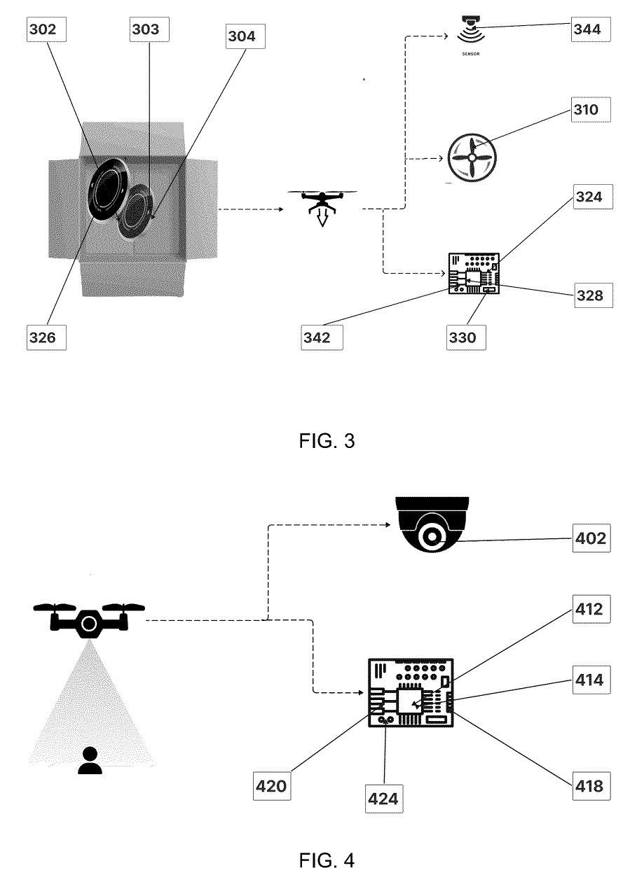

FIG. 3 depicts as exemplary emergency response device with a docking platform, according to some embodiments of the present disclosure. As shown, a docketing platform 302 employs a secure, magnetic attachment system that provides easy and quick docking for the flying object, ensuring firm attachment and simple release when activated. In some embodiments, a charging system 303 integrates advanced conductive charging technology to efficiently power the flying object without the need for physical connectors, enhancing durability and ease of use. In some embodiments, a battery system 304 includes a quick-release mechanism that allows for rapid battery changes in the field, minimizing downtime and maximizing operational readiness. In some embodiments, an energy management system integrates sophisticated algorithms to optimize power consumption and extend operational duration effectively.

In some embodiments, an aerodynamic design optimizes the body of the flying object to reduce air resistance, allowing for stable speeds and more efficient power usage, and is crafted from lightweight, durable materials to withstand various environmental conditions while minimizing drag for efficient flight. In some embodiments, a propulsion system 310 includes brushless micro motors paired with precision-engineered propellers that provide powerful lift and agile maneuverability, essential for rapid deployment and stable flight. In some embodiments, a vibration dampening system incorporates specialized materials and structures to dampen vibrations from the motors and flight movements, ensuring stable video capture and extending the life of sensitive electronic components. In some embodiments, the structural frame of the flying object is made from lightweight composite materials such as carbon fiber, which offer high strength-to-weight ratios, making the flying object robust yet nimble during operations.

In some embodiments, a retractable landing gear features a compact, retractable landing gear design that minimizes drag during flight and protects the gear components when not in use or during landing on uneven surfaces. In some embodiments, a water-resistant sealing features seals and gaskets that provide water resistance, enabling the flying object to operate in moist or rainy conditions without compromising internal components. In some embodiments, an impact protection housing employs an impact-resistant housing that protects sensitive components like cameras and sensors from shocks and collisions, ensuring reliability in challenging environments.

In some embodiments, a printed circuit board (PCB) 324 supports the intricate electronic architecture, housing the MCU, communication modules, and other components in a compact and efficient layout, optimized for weight and power considerations. In some embodiments, a lighting system 326 is equipped with LED lights to facilitate nighttime operations and visual alerts during emergencies or when the flying object is activated or returns to the dock.

In some embodiments, an RFID reader 328 allows for automated identification and authentication of the flying object (which includes an RFID bar code) when it approaches the docking platform, enhancing security and personalized settings activation. In some embodiments, expandable ports 330 allow for the connection of additional modules or accessories to enhance the capabilities of the docking platform, such as external sensors or expanded communication tools. In some embodiments, an onboard storage medium utilizes high-speed, solid-state memory to store critical data locally, ensuring information retention in case of communication disruptions. In some embodiments, a surveillance system includes additional cameras and sensors on the flying object to monitor the surrounding area, providing enhanced security for the docked flying object.

In some embodiments, a weatherproof enclosure shields the flying object and the docking platform from environmental elements such as rain, dust, and extreme temperatures, constructed from high-grade, durable materials. In some embodiments, the GPS module (shown in FIG. 2) offers precise geolocation capabilities, enabling accurate positioning and tracking of the flying object's movements. In some embodiments, a communication interface (shown in FIG. 2) utilizes Bluetooth and Wi-Fi protocols to ensure seamless and reliable data transmission between the flying object and the mobile app. In some embodiments, a collision avoidance system 342 leverages ultrasonic sensors and AI-driven algorithms to navigate safely around obstacles. In some embodiments, environmental sensors 344 measure atmospheric conditions such as temperature, humidity, visibility and air quality, enriching the data sent back for situational analysis.

FIG. 4 depicts as exemplary flying object with a docketing mechanism, according to some embodiments of the present disclosure. As shown, a (high-resolution) camera 402 captures detailed videos and images from the scene. In some embodiments, camera 402 includes a night vision and wide-angle lens enhance the camera's capabilities, allowing it to operate effectively in low-light conditions and cover expansive viewing angles, ensuring comprehensive surveillance and monitoring capabilities around the clock. In some embodiments, real-time video streaming facilitates the immediate transmission of live video feeds to the mobile app and emergency responders. In some embodiments, the software includes an AI-powered analysis engine that employs machine learning algorithms to analyze the video feed in real time, identifying and classifying various elements within the scene, such as recognizing faces, voice recognizing, detecting potential hazards, and interpreting motion patterns, enhancing situational awareness.

In some embodiments, a communication module 412 ensures robust connectivity using a combination of Wi-Fi and LoRa technologies, where LoRa provides long-range, low-power communication ideal for expansive emergency scenes where traditional networks might fail.

In some embodiments, a real-time operating system (RTOS) manages the software processes and ensures that real-time data handling is synchronized and error-free, effectively prioritizing tasks to handle high-priority alerts instantaneously. In some embodiments, a PCB 418 supports the intricate electronic architecture, housing the MCU 420, communication module, and other components in a compact and efficient layout, optimized for weight and power considerations. In some embodiments, the MCU 420 serves as the central processing unit for the flying object, coordinating all computational tasks and ensuring efficient operation of both the camera and AI functionalities. In some embodiments, an edge computing capabilities allow initial data processing to be performed on the flying object itself, reducing the need to send all data to the cloud, which minimizes latency and bandwidth use. In some embodiments, a lighting system 424 is equipped with LED lights to facilitate nighttime operations and visual alerts during emergencies or when the flying object is activated or returns to the dock.

In some embodiments, a behavioral recognition software analyzes behavior patterns captured by the camera, using AI to detect signs of distress or abnormal activities, triggering alerts when anomalies are detected. In some embodiments, environmental adaptation algorithms enable the camera and AI systems to adjust settings automatically based on environmental conditions, such as changes in light, weather, or other external factors affecting visibility and sensor performance.

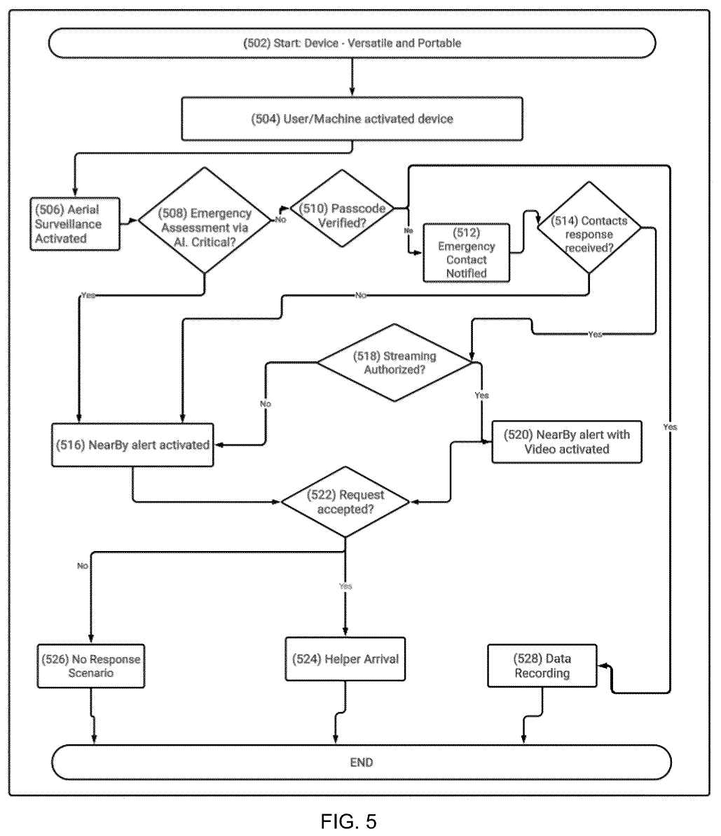

FIG. 5 illustrates an exemplary process flow for an emergency response portable device, according to some embodiments of the present disclosure. As shown in block 504, a portable device 502 is activated by a user. The portable device 502 can be worn on various body parts including the wrist, ankle, back, neck, or head, or carried discreetly in a pocket or purse, making it suitable for daily wear and emergency situations alike. The portable device 502 can be carried by a person in a pocket, bag or the like. Device activation occurs when the user presses or touches the ‘Help’ button on the device. This triggers a hardware mechanism integrated with software controls that immediately detect and transmit the activation signal, initiating the detachable flying object to fly and hover over the user.

In block 506, an aerial surveillance is activated. A mini detachable flying object (e.g., a micro drone) equipped with high-resolution cameras and flying technology, deploys from the device. In some embodiments, the flying object utilizes stabilization and hovering capabilities to maintain a position above the user, beginning immediate video recording to the cloud and live streaming. In block 508, an emergency assessment is performed by the device and the recorded video is analyzed in real-time, for example, by artificial intelligence executing on the device. The AI system uses machine learning algorithms to classify the nature of the emergency, whether it be an accident, medical emergency, or another critical situation, based on visual and audio inputs from the environment.

In block 510, user's passcode is verified. In some embodiments, the system (device) prompts the user to enter a predefined passcode on the device or associated mobile app within a pre-configured time, allowing them to cancel the emergency alert if safe. In block 512, an emergency contact is notified. If the passcode is not entered within the allotted time, suggesting the user may be incapacitated or unable to deactivate the alert manually, all emergency contacts preset in the mobile app are immediately notified. This notification includes live video streaming, providing a comprehensive and elevated view of the user's surroundings.

In block 514, contact response is checked. The system monitors to see if any emergency contacts have acknowledged the alert within pre-configured time, ensuring there is recognition of the user's situation. In block 516, a nearby alert is activated. The system assesses responses from nearby app users and identifies any users who accept the request for help, initiating a connection between them and the distressed user. If initial alerts to nearby users go un-responded, the notification radius are automatically increased to ensure maximum coverage and potential assistance as per the configuration done by user. In bock 518, video streaming is authorized and initiated. Checks are performed to confirm if sufficient emergency contacts have authorized the continuation of streaming the live situation to nearby users who remain anonymous.

In block 520, nearby alert with the video is activated. The system evaluates active users in the vicinity through the app's location and disseminates notifications along with live video streaming to anonymous users' devices. This alerts them to the presence of a user in urgent need of assistance, which may arise from various circumstances. In some embodiments, the system automatically expands the search radius according to user-defined settings, to enhance the likelihood of obtaining help and maximizing coverage and potential support. The system prioritizes notifications based on the AI and multiple factors specific skills of users relevant to the emergency, enhancing the response efficiency, for example, skill relevance, proximity, availability, past response history, equipment and resources, physical capability, certifications and qualification, legal and ethical constraint, communication preferences, language and cultural knowledge etc.

In block 522, the user request in the emergency situation is examined. When the request for assistance is accepted (“Yes”), both the helper and the requester receive essential details including each other's names, current locations, and a live route map detailing the path and remaining distance between them. As the helper proceeds towards the requester, live streaming of the situation continues, ensuring both parties can coordinate and prepare appropriately, enhancing real-time situational awareness. In block 524, the helper arrives at the location of the requested. Upon the helper's arrival at the location, they provide necessary assistance or coordinate with emergency services or family members as required. The system confirms successful connection and assistance initiation between the user and the helper.

In block 526 (“No” from block 522), if no assistance is available or forthcoming, the system alerts the user to attempt another request, ensuring they are aware of the situation. Alternatively or in addition, when no assistance is available, the system may be programmed to make an emergency call to a nearby hospital or clinic. In block 528, relevant data is recorded for future use. The data may be recorded on the portable device, a computing device in communication with the portable device, or both. In some embodiments, throughout the emergency process, all critical data, including video recordings, user interactions, and operational timestamps, are securely stored in the user's profile, utilizing cloud storage solutions with advanced encryption and data protection measures to safeguard privacy and data integrity.

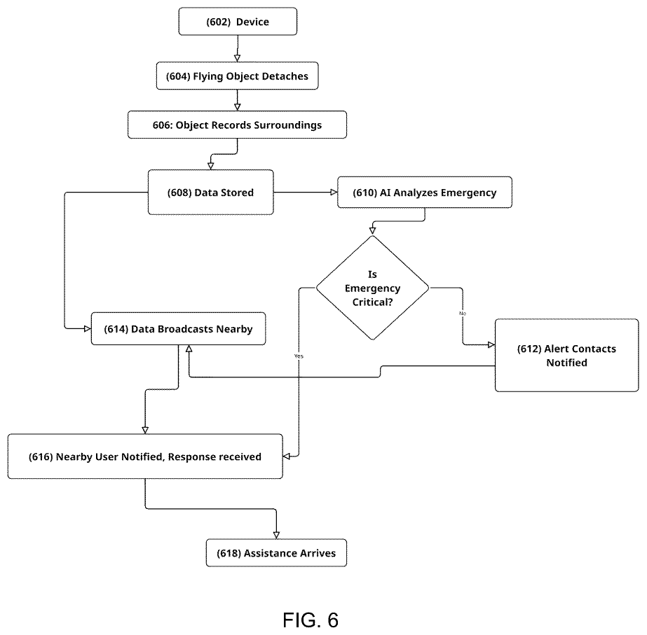

FIG. 6 illustrates as exemplary process flow of usage of an emergency response portable device, according to some embodiments of the present disclosure. As shown in block 602, the portable device with detachable flying object is connected (paired) with a mobile app executing on a portable computing device, such as a smarty phone. In block 604, upon activating an input (e.g., pressing or touching a button or display area) or automatic activation in case of an emergency situation, the flying object is detached from the device and starts hovering over the user with its camera activated. In block 606, the flying object starts recording the user and his surroundings and the data is stored to user profile in block 608.

In block 610, the software, for example AI and Machine Learning algorithms, determine the nature of the emergency. In block 612, an emergency contact notification is sent to one or more app users in the area. In block 614, based on user's programmed configuration, relevant data, such as the precise location, videos, information about the user and their medical conditions is broadcast to all nearby app users. Responses from the nearby users are received in block 616 and they arrive for assistance in block 618.

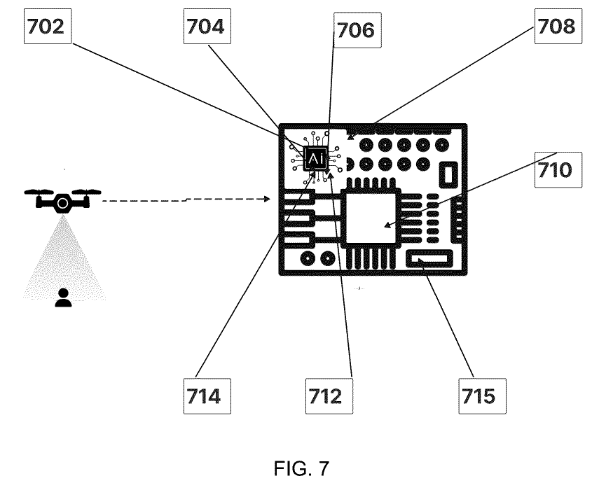

In some embodiments, AI plays a useful role in both the mobile app and the portable device. AI algorithms analyze the data to detect potential ‘type’ of emergency situations before they escalate. The AI enhances the system's decision-making processes, such as identifying the most appropriate responders based on proximity, availability, and the nature of the emergency. In some embodiments, the AI routines extend to predictive analytics, where machine learning models forecast areas with increased risk of incidents based on historical data and real-time inputs. This predictive feature allows for preemptive action, potentially preventing emergencies from occurring, as explained below with respect to FIG. 7.

FIG. 7 shows as exemplary process flow for predictive crime and emergency alerts, according to some embodiments of the present disclosure. Real-time crime and emergency alerts through artificial intelligence and machine learning, based on user-uploaded videos for specific regions, areas, or cities. This system predicts the current density of crime or emergencies, like traffic predictions on Google Maps, offering live updates. As shown in block 702, an AI-powered threat detection process implements AI algorithms capable of analyzing data from various sensors to detect potential threats or emergencies. The process utilizes machine learning models to identify patterns and anomalies in user behavior, environmental conditions, and surrounding activities.

In block 704, predictive assistance is performed. In some embodiments, an AI predictive models develops artificial intelligence models that leverage historical data sets, user preferences, and real-time environmental factors to accurately predict potential safety hazards or risks, for example, crime rate analysis, weather-related risks, crowd sourced data for emergency prevention, health emergency forecasting, traffic accident prediction. In some embodiments, the system utilizes the predictive capabilities to offer timely alerts and actionable recommendations to users. This proactive approach aims to mitigate risks and preemptively address potential emergencies, enhancing user safety through anticipatory guidance.

In block 706, context-aware responses are generated, for example using dynamic situational adjustment. In some embodiments, the portable device includes the capability to dynamically tailor its responses based on the specific context of the situation and the individual needs of the user. Real-time command processing: incorporate advanced natural language processing (NLP) capabilities to accurately interpret and respond to user commands and requests in real time, enhancing the interactivity and responsiveness of the device. In block 708, behavioral analysis and behavioral pattern recognition is performed. In some embodiments, the portable device utilizes AI algorithms to analyze user behavior and activity patterns. This analysis helps detect any deviations or unusual signs that may indicate distress or emergent situations. For example, fall detection, stress and anxiety monitoring, wandering detection for dementia patient, sleep pattern analysis, fitness routine adherence may be detected. In some embodiments, the portable device performs emotional and biometric assessment utilizing biometric data and behavioral cues to assess the user's emotional state and overall well-being. The system can then trigger tailored responses or interventions based on these assessments to provide appropriate support when needed.

In block 710, an adaptive communication with other devices is performed. For example, an AI-driven communication systems integrates intelligent communication systems that facilitate seamless interaction between portable device users and emergency responders or support networks. In some embodiments, a customized communication protocol automatically adjusts communication protocols and responses based on the urgency and severity of each situation, ensuring prioritization of user safety and operational efficiency.

In block 712, personalized safety recommendations are made. For example, an AI-based recommendation engine develops personalized safety recommendations that provide customized safety tips, guidance, and resources, specifically tailored to match each user's unique circumstances and preferences. In some embodiments, data-driven safety insights: continuously enhance the relevance and effectiveness of safety recommendations by analyzing user data, feedback, and emerging safety trends. In block 714, the system performs continuous learning and improvement. Self-improving AI functionality enables the portable device to continuously learn from user interactions, feedback, and incident outcomes to enhance its predictive accuracy and operational effectiveness over time. Adaptive learning algorithms that evolve in response to changing user needs, emerging threats, and advancements in technology are generated by the system.

In block 715, the system leverages external AI services and platforms to augment the capabilities of the portable device, including but not limited to natural language processing APIs, advanced computer vision algorithms, and sophisticated predictive analytics tools. Interoperability with third-party AI solutions provides a seamless integration and interoperability to draw on specialized expertise and expand the data resources available for enhanced decision-making and user support.

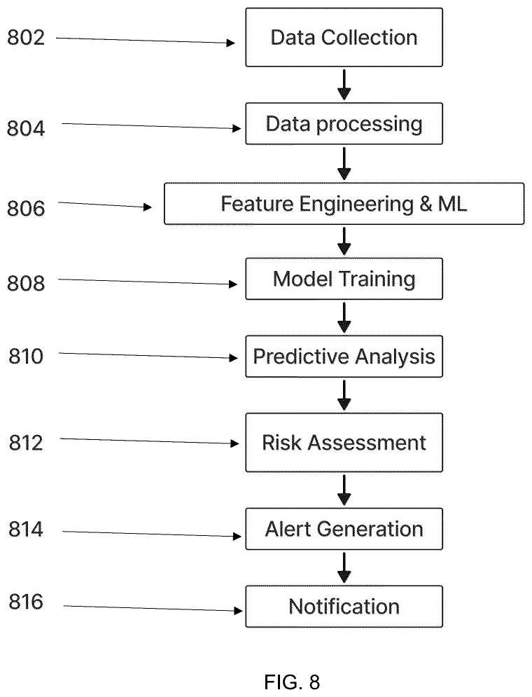

FIG. 8 depicts as exemplary process flow for model training and notification generation of a portable device, according to some embodiments of the present disclosure.

As shown in block 802 (Date Collection), upon activation of the device, data collection is performed by gathering data from various sources, including user activity patterns, biometric data, environmental conditions, and historical incident data. In block 804 (Date Processing), data preprocessing is performed to cleanse and prepare the collected data for analysis, addressing missing values, outliers, and inconsistencies. In block 806, feature engineering and selection routines extract relevant features from the data and select those with the most predictive power for the ML models.

In block 808 (Model Training), model training routines train machine learning models on the preprocessed data using algorithms such as regression, classification, or clustering. In block 810 (Predictive Analysis), predictive analysis routines apply the trained models to new data to predict potential safety hazards or risks. In block 812 (Risk Assessment), risk assessment & probability calculation are performed to assess the likelihood and severity of predicted risks, calculating risk scores or probabilities for different scenarios.

In block 814 (Alert Generation), alert generation & recommendation routines generate proactive alerts and recommendations based on the predicted risks, providing users with actionable advice to mitigate potential emergencies. In block 816 (Notification), user notification routines notify users of the predicted risks and recommended actions through the portable device or mobile application, ensuring timely awareness and response. The present disclosure enhances personal safety for individuals in various environments, including urban, suburban, and remote areas. It is particularly beneficial for: individuals in vulnerable situations, such as the elderly or those with health issues; people residing in regions with high crime rates or inadequate emergency infrastructure; and adventurers and outdoor enthusiasts who may encounter risks in isolated areas. Moreover, the disclosure supports community safety initiatives by providing a tool that strengthens neighborhood watch programs and fosters a cooperative safety network among local residents.

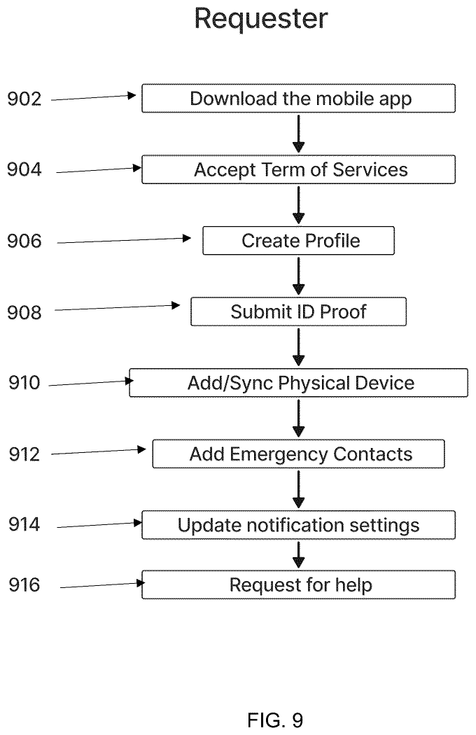

FIG. 9 shows as exemplary process flow for a requester's process, according to some embodiments of the present disclosure. In some embodiments, users begin by downloading the mobile app from their respective app stores, in block 902. The app serves as the central interface for managing the portable device, accessing emergency services, and configuring personal settings. In some embodiments, upon first launching the app, users are prompted to accept terms of services, in block 904. These terms outline the legal conditions and user responsibilities associated with the use of the mobile app and services. In some embodiments, after accepting the terms, users create profile within the app, in block 906. This profile includes basic information such as name, address, and contact details, which are crucial for tailoring the app's emergency response services to the user's specific needs. In some embodiments, to enhance security and verify the identity of the user, the app requires Submission of ID Proof as part of the KYC (Know Your Customer) process, in block 908. This process ensures that all interactions and transactions are securely tied to verified individuals.

In some embodiments, users then add or sync the physical device with the mobile app, in block 910. This may involve scanning a QR code on the device or manually entering a device identification number, ensuring that the device can communicate seamlessly with the app for real-time data exchange and emergency responses. In some embodiments, users can add emergency contacts and store the contact information of several trusted individuals or emergency contacts within the app, in block 912. These contacts will be notified in case of an emergency. In some embodiments, the app allows users to update notification settings, including the type of alerts they receive, the conditions under which they are activated, and how they prefer to be contacted in different scenarios, in block 914. This customization ensures that users receive relevant and timely notifications suited to their personal preferences and safety needs.

In some embodiments, in case of an emergency, users can request for help through the app, in block 914. This can be done manually by pressing a help button on the app or the portable device. The system then uses the user's location and the nature of the emergency to notify appropriate emergency contacts or nearby device or/and app users, providing live video streaming and other critical information to responders.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention as defined by the appended claims and drawings.

1. An emergency response portable device comprising:
a housing;
a microcontroller;
a memory for storing software;
a flying object docked to the portable device;
a docking platform for docking the flying object;
a communication circuit; and
an activation mechanism to activate an emergency response from the portable device in case of an emergency situation including a fall or a crash, wherein
when the portable device is activated in case of the emergency situation, the flying object is released from the docking platform to hover in the air to maintain a position above the portable device, and the communication circuit transmits an emergency signal to a remote location reporting the emergency situation.

2. The portable device of claim 1 further comprising GPS module for determining a location of the portable device, wherein the emergency signal includes the location of the portable device.

3. The portable device of claim 1 further comprising one or more sensors for monitoring health parameters of a user including one or more of blood oxygen levels, skin temperature, heartbeat, blood pressure and electrodermal activity, and wherein the emergency signal includes the health parameters of the user.

4. The portable device of claim 1 further comprising a touch-sensitive surface for gesture controls or device control.

5. The portable device of claim 1 further comprising an RFID reader for identification and authentication of the flying object when it approaches the docking platform from hovering to dock with the portable device.

6. The portable device of claim 1, wherein the software includes artificial intelligence routines for detecting signs of distress or abnormal activities of a user, triggering alerts when anomalies are detected, and adjusting settings of a camera based on environmental conditions.

7. The portable device of claim 6, wherein the artificial intelligence routines uses machine learning algorithms to classify a nature of the emergency situation, based on visual and audio inputs from one or more environment sensors and cameras.

8. The portable device of claim 6, wherein the artificial intelligence routines forecast areas with increased risk of incidents based on historical data and real-time inputs.

9. The portable device of claim 1, wherein the flying object includes a camera for streaming images, and a collision avoidance system to navigate safely around obstacle.

10. The portable device of claim 1, wherein the flying object includes environmental sensors to measure environmental conditions including one or more of temperature, humidity, visibility and air quality.

11. The portable device of claim 1, wherein the flying object includes collision avoidance system.

12. A method, executed on a portable device, for emergency response to an emergency situation, the method comprising:
detecting an emergency situation including a fall or a crash;
classifying a nature of the emergency;
releasing a flying object docked to the portable device to hover in the air to maintain a position above the portable device; and
transmitting an emergency signal to a remote location reporting the emergency situation, wherein the emergency signal includes a location of the portable device, the nature of the emergency and health parameters of a user of the portable device.

13. The method of claim 12, further comprising streaming images to the remote location by the flying object.

14. The method of claim 12, wherein the emergency signal in transmitted to a response user at the remote location to provide help to the user of the portable device.

15. The method of claim 12, further comprising detecting signs of distress or abnormal activities of the user of the portable device, triggering alerts when anomalies are detected, and adjusting settings of a camera based on environmental conditions.

16. The method of claim 12, further comprising authenticating the flying object when it approaches the portable device from hovering to dock with the portable device.

17. The method of claim 12, further comprising forecasting areas with increased risk of incidents to the user of the portable device, based on historical data and real-time inputs.

18. The method of claim 12, further comprising measuring environmental conditions including one or more of temperature, humidity, visibility and air quality to provide protection against impacts.

19. The method of claim 12, further comprising monitoring health parameters of a user including one or more of blood oxygen levels, skin temperature, heartbeat, blood pressure and electrodermal activity, and wherein the emergency signal includes the health parameters of the user.

20. The method of claim 12, further comprising utilizing machine learning algorithms to classify a nature of the emergency situation, based on visual and audio inputs from one or more environment sensors and cameras.
